(19) United States
(12) Patent Application Publication
(10) Pub. No.: US 2026/0223818 A1
(43) Pub. Date: Aug. 6, 2026

(54) SYSTEMS, DEVICES, AND METHODS FOR PREVENTING ENCOUNTERS WITH POISONOUS ANIMALS

(71) Applicant: Toad Busters, LLC, Port St. Lucie, FL (US)

(72) Inventor: Jeannine Tilford, Port St. Lucie, FL (US)

(21) Appl. No.: 19/531,222

(22) Filed: Feb. 5, 2026

Related U.S. Application Data
(60) Provisional application No. 63/754,859, filed on Feb. 6, 2025.

(51) Int. Cl. A01K 15/04; A01K 3/00; A01K 15/00

(52) U.S. Cl. CPC A01K 15/04; A01K 3/00; A01K 15/006; A01K 2003/007

(57) ABSTRACT

Devices, systems, and methods for preventing or minimizing encounters with dangerous animals, such as toad canes. The devices, systems, and methods may include barrier panels secured to a structure, such as a fence defining an area to be protected.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 63/754,859, entitled, “SYSTEMS, DEVICES, AND METHODS FOR PREVENTING ENCOUNTERS WITH POISONOUS ANIMALS,” filed on February 6, 2025. The contents of the above referenced application are incorporated herein by reference in its entirety.

### FIELD OF THE INVENTION

The present disclosure relates to systems, devices, and methods of preventing dangerous animals from entering an area; to systems, devices, and methods for preventing or minimizing encounters with cane toads, thereby preventing or minimizing toxic cane toad poisoning in animals; and more particularly, to systems, devices, and methods relating to a barrier to prevent or minimize encounters with cane toads, thereby preventing or minimizing toxic cane toad poisoning in animals.

### BACKGROUND OF THE INVENTION

Rhinella marina, commonly known as cane toads, or “bufo” or “marine” toads are large amphibians. They are poisonous to many animals, particularly household pets, such as dogs or cats, and are responsible for numerous visits to animal hospitals. Cane toads house a poisonous white substance, bufotoxin, in large glands on the side of their head. When threatened, the cane toad releases bufotoxin to ward off the attacking predator. Often the “attacking predator” is a curious dog that bites or simply licks the toad.

Exposure to bufotoxin, either through the bite or lick, or being sprayed into their eyes, can have serious ramifications. Penetration of the bufotoxin into a dog’s mucous membrane (inside of the mouth, the conjunctiva of the eye, lining of the stomach) may cause hypersalivation vocalization, bright red gums, vomiting, disorientation, stumbling, circling, seizures, hyperthermia, rapid, abnormal heartbeat, and coma. In the most severe cases, death can occur. Progression of the symptoms and poisonous effects are rapid once exposed to the toxin. As such, early treatment is critical to successful outcomes.

Once exposed to bufotoxin, many pet owners rush their dogs to a treatment site, such as their veterinarian’s office or pet hospital for treatment. Early treatment is critical to success, and the time it takes to get to a treatment site can be an issue. One of the best ways to avoid being in such a precarious position, either exposure to the toxin or trying to get medical intervention, is to avoid contact or being exposed to the cane toad.

Embodiments described in the disclosure provide devices, systems, and methods for preventing or minimizing encounters with cane toads, thereby preventing or minimizing toxic cane toad poisoning in animals.

### SUMMARY OF THE INVENTION

The present disclosure provides embodiments of devices, systems, and methods for preventing or minimizing encounters with dangerous animals, such as cane toads. The devices, systems, and methods may include barrier panels secured to a structure, such as a fence defining an area to be protected.

Accordingly, it is an objective of the disclosure to teach devices, systems, and methods for preventing or minimizing encounters with dangerous animals.

It is a further objective of the disclosure to provide devices, systems, and methods for preventing or minimizing encounters with dangerous animals that produce toxins.

It is yet another objective of the disclosure to provide devices, systems, and methods for preventing or minimizing encounters with cane toads.

It is a still further objective of the disclosure to provide devices, systems, and methods for preventing or minimizing toxic cane toad poisoning in animals.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic representation of the devices, systems, and methods for preventing or minimizing encounters with dangerous animals, shown with interior placement;

FIG. 2 is a schematic representation of the devices, systems, and methods for preventing or minimizing encounters with dangerous animals, shown with exterior placement;

FIG. 3 is an illustrative embodiment of a barrier, shown as a screen or mesh panel;

FIG. 4 is an illustrative embodiment of a barrier, shown as a plastic panel;

FIG. 5A illustrates an example of the screen or mesh panel secured to a fence;

FIG. 5B is a close-up view of edging along the fence a home to seal gaps therebetween;

FIG. 6 is another illustration of the screen or mesh panel secured to a fence, illustrating the use of fastening members;

FIG. 7 is an illustrative embodiment of the screen or mesh panel secured to a semi-private, wood fence;

FIG. 8A is an illustrative example of a threshold;

FIG. 8B illustrates the threshold with flat edging;

FIG. 9 is an illustrative example of a molding;

FIG. 10 is an illustrative example of a brush sweep;

FIG. 11 illustrates an embodiment of the threshold and gate;

FIG. 12 is an alternative illustration of the threshold and gate;

FIG. 13 illustrates the overlapping of the screen panels, illustrating the use of molding and overlapping mesh screens;

FIG. 14 illustrates the use of the brush sweep to fill gaps;

FIG. 15A illustrates the use of bottom edging;

FIG. 15B is an alternative close up view of the bottom edging;

FIG. 16 illustrates the placemat of the mesh screens around a gate post; and

FIG. 17 is an illustrative embodiment of a clear plastic panel secured to the gate.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

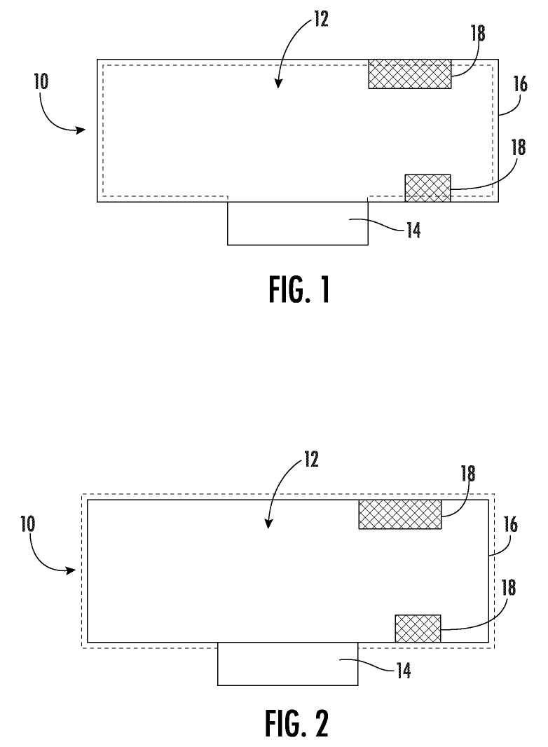

Referring to FIGS. 1-17, illustrative embodiments of devices, systems, and methods for preventing or minimizing encounters with dangerous animals that produce life-threating toxins, such as the cane toad, are provided. Referring specifically to FIG. 1, a schematic representation of the devices, systems, and methods for preventing or minimizing encounters with dangerous animals, referred to generally as an animal barrier system 10, is illustrated. The animal barrier system 10 is described for use in preventing encounters with cane toads. However, the barrier system 10 may be used to prevent encounters with other animals as well. The animal barrier system 10 is designed to provide a barrier for an area so that encounters with cane toads are minimized or eliminated. By providing a specifically designed barrier system, cane toads are prevented from entering the area, thus keeping pets safe from potential cane toad toxin exposure and poisoning.

As illustrated in FIG. 1, the animal barrier system 10 is constructed and arranged to provide a barrier for an area, illustrated herein as a plot of land 12. The plot of land 12 may be associated with a structure 14, such as a house. The plot of land 12 may be defined by an existing fence 16 (illustrated as a solid line). As used herein, the term fence defines a structure (may be made of various materials, including, but not limited to wood (natural or manufactured), metal, vinyl, wire) which defines an area of land, such as a property or a space, typically built to provide privacy or keep things in or out of such area. The animal barrier system 10 (indicated generally as broken lines) is constructed and arranged to engage with the fence 16 via attachment to various sections and portions thereof.

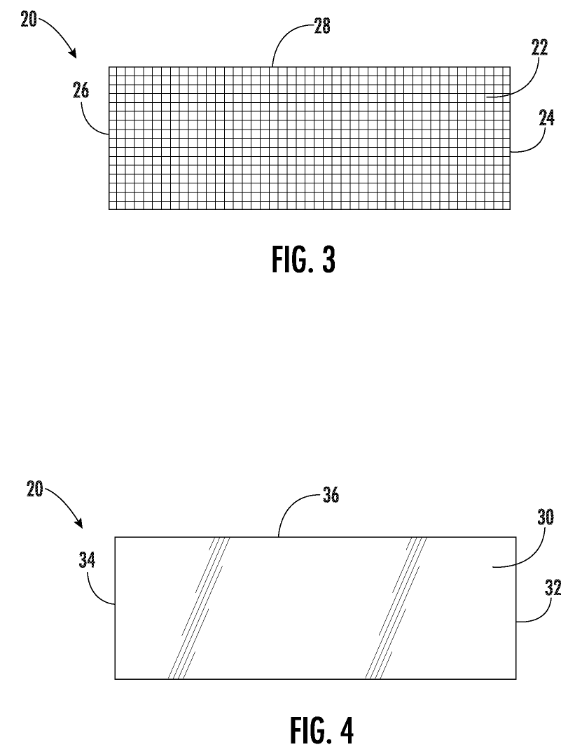

The fencing 16 may include ingress/egress structures, illustrated as a gate(s) 18. As the opening of the gates(s) 18 may be point(s) of cane toad entrance, the animal barrier system 10 comprises structures that help minimize the opportunity for the cane toads to gain entrance within the plot of land 12 while the gates(s) 18 is/are open. In FIG. 1, the animal barrier system 10 is shown placed within the interior of the plot of land 12 defined by the fence 16 and secured to the interior portion of the fence 16. Alternatively, the animal barrier system 10 may be placed within the exterior of the plot of land 12 defined by the fence 16 and secured to the exterior portion of the fence 16, see FIG. 2.

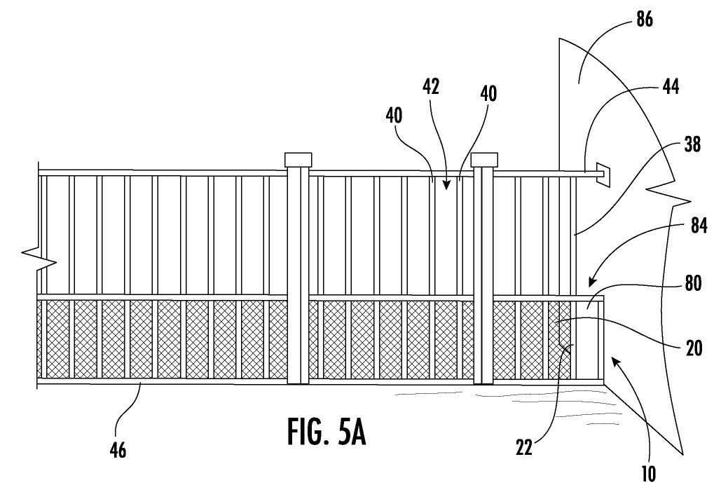

In describing the animal barrier system 10, or any methods related thereto, the systems and methods may include any component individually or in any combination of components. In certain embodiments, the animal barrier system 10 may comprise a barrier 20. The barrier 20 may be, for example, a screen or mesh panel 22, see FIG. 3. The screen or mesh panel 22 may include a first end 24, a second, opposing end 26, and a main body 28 separating the first end 24 and the second end 26. As an illustrate example, the mesh panel 22 may be made of TEXTILENE (a woven polyester strand mesh with each of the polyesters strands being coated with polyvinyl), having a basket weave pattern.

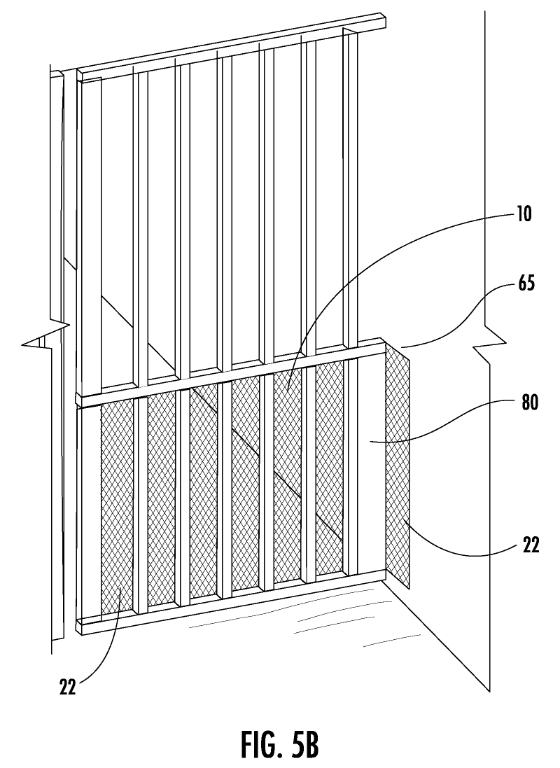

The mesh panel 22 may have a strength rating, such as a strength rating of at, or at least, or above 387 pounds per square inch. The mesh panel 22 maybe UV resistant and designed to be barely noticeable, but allow an individual to see through it. In certain embodiments, the screen or mesh panel may be defined by its screen openings per square inch or centimeter having a sufficient size to allow passage of materials, such as air or water, and forms of energy, such as light, to pass therethrough, but prevent said animal from using it to climb on or pass through. Alternatively, the barrier 20 may be a solid panel 30, see FIG. 4, made of a clear plastic material. The solid panel 30 may also include a first end 32, a second, opposing end 34, and a main body 36 separating the first end 32 and the second end 34.

In certain embodiments, the animal barrier system 10 may include edging (may also be referred to as an edging body). Unless otherwise provided, the edging or edging body may be a hard edging made of a plastic polymer body that does not bend, or a soft edging made of a plastic polymer body that is bendable. The edging or edging body may be any height or length.

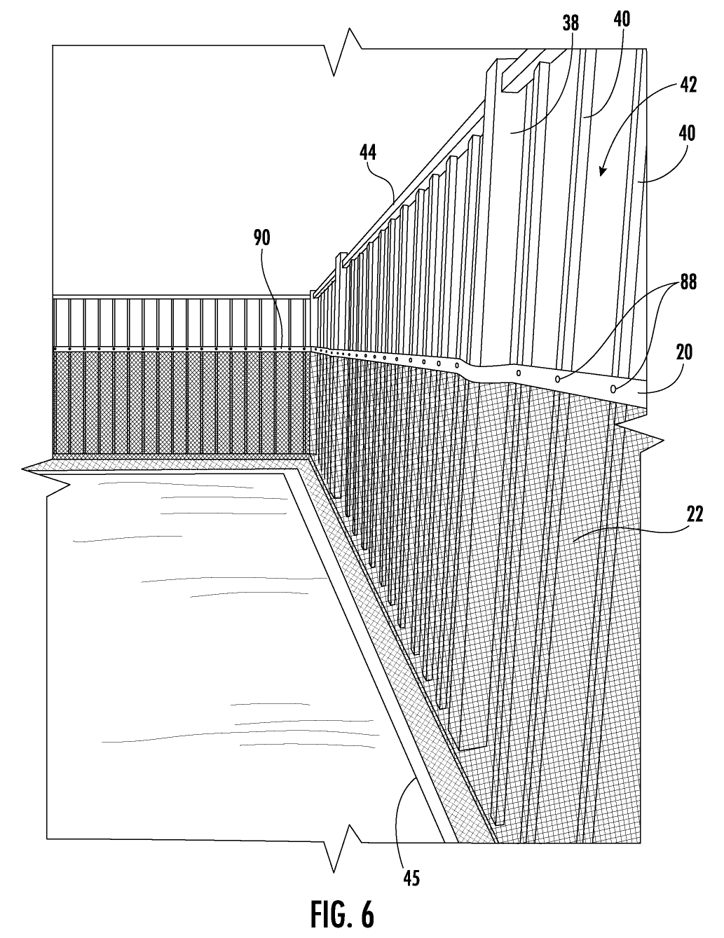

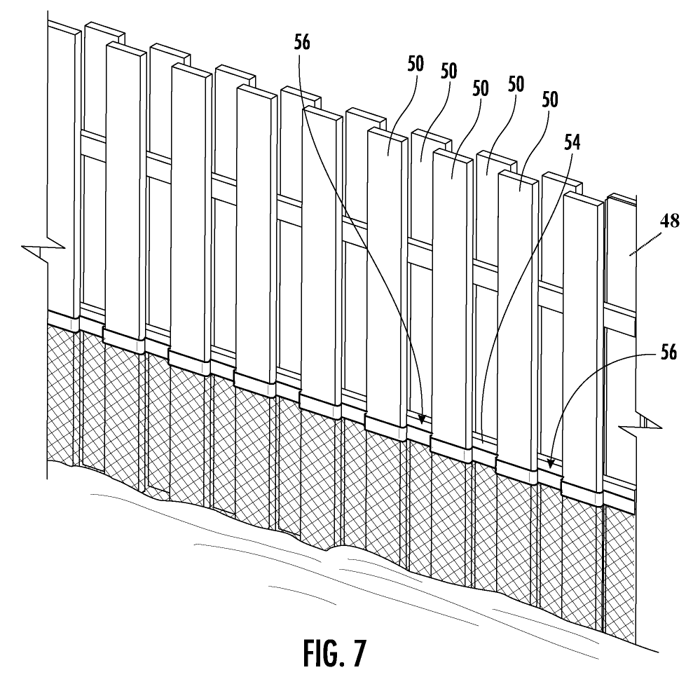

In use, the barrier 20 secures to a primary structure, see FIG. 5A, FIG. 5B, or FIG. 6. As illustrated in the figures, one or more of the mesh panels 22 are attached and secured to a fence 38, illustrated as a wrought iron fence with verticals 40 separated by spaces 42. The top and bottom of the fence 38 may be capped by horizontal members 44 (top of fence, also referred to as upper portion or upper edge) and 46 (bottom of fence, also referred to as lower portion or lower edge). In certain embodiments, the barrier 20 is inserted into the ground, such as, at, or at least 4-6 inches below ground level (ground level shown as refence number 45, FIG. 6), and buried to prevent animals from digging under the fence 38. In certain embodiments, the barrier 20 may be curled or bent a distance, with soil or dirt filled or placed on top of the curled or bent section.

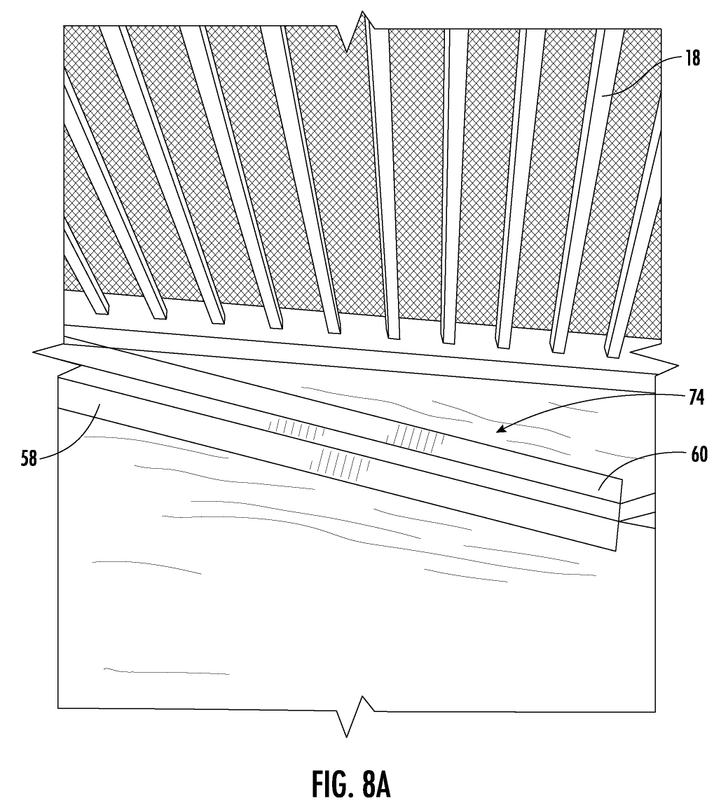

Referring to FIG. 7, the barrier 20 is secured to a semi-private style, wood fence 48. The semi -private style, wood fence 48 has partial overlapped adjacent vertical boards 50. For these types of fencing, the barrier 20 may be installed on an intermediate horizontal fence board (for example, a horizontal board 54 located up to a middle height of the semi-private style, wood fence 48 and sealed between the vertical boards 50 (see arrows 56) to keep the cane toads from climbing the boards.

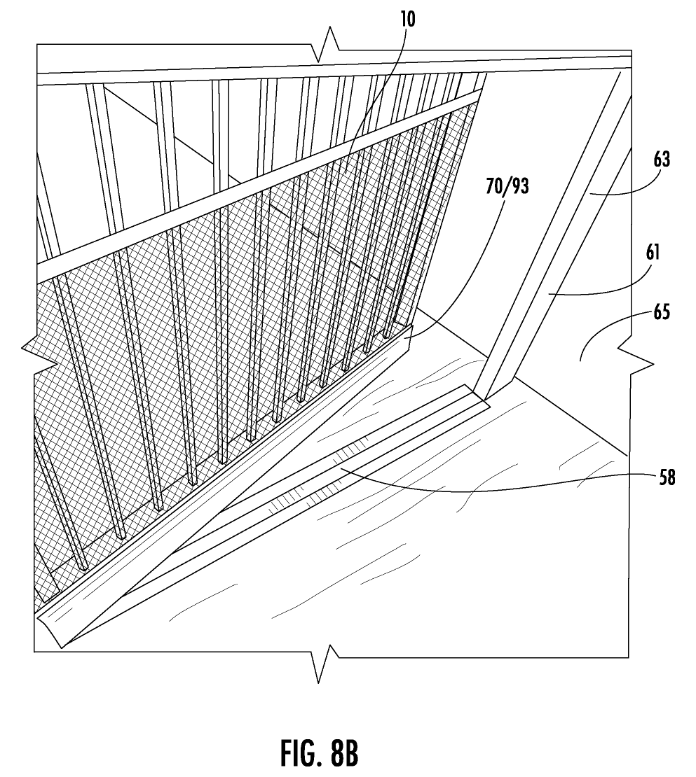

Embodiments of the animal barrier system 10 may include a threshold 58, see FIG. 8A and FIG. 8B, positioned at or under gate(s) 18. As used herein, the threshold 58 may be any material placed under a fence gate and provides a solid surface in which the gate can open and close thereover. The threshold 58 acts as a base to allow the gate to seal thereto, preventing or not allowing animals to pass thereunder, such as through digging or burrowing. The threshold 58 is illustrated herein as a channeled, rubber speedbump 60.

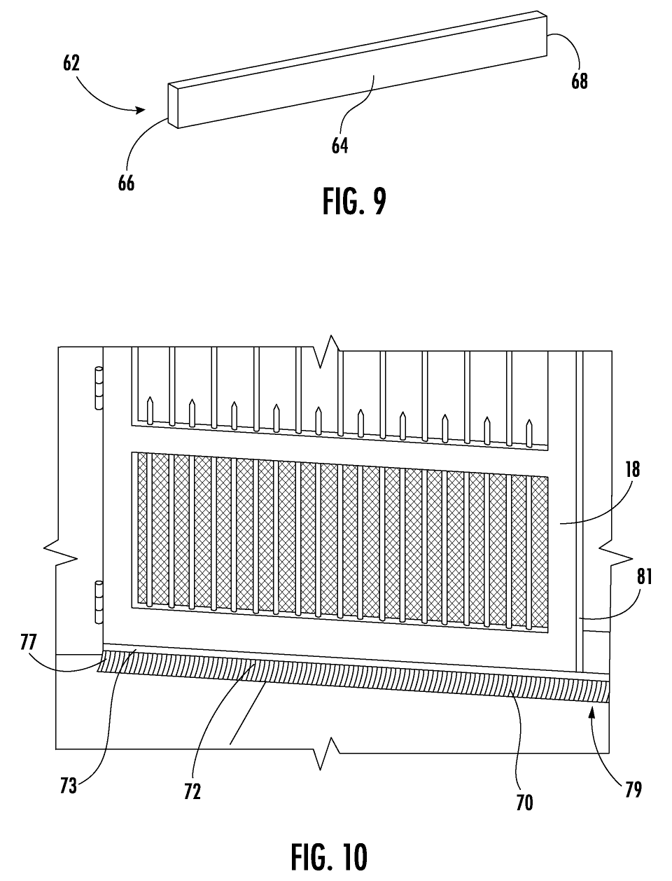

Embodiments of the animal barrier system 10 may include molding 62, see FIG. 9. The molding 62 may include an elongated body 64, a first end 66 and a second opposing end 68. The molding 62 may be used to seal seams between mesh panels 22 and/or small gaps in the fence 38. The molding 62 may be made of any type of material, such as aluminum.

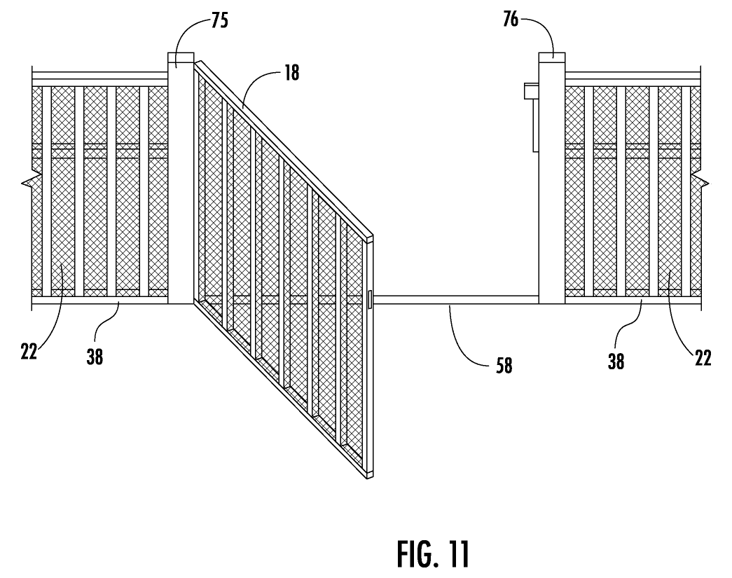

Embodiments of the animal barrier system 10 may include a brush sweep 70 see FIG. 10. The brush sweep 70 may include an elongated body 72 which attaches to the bottom portion of the fence door 18. As illustrated, the elongated body 72 extends along the entire length of the bottom 73 of the gate 18. The elongated body 72 includes a plurality of bristles 77. The bristles 77 are sized, shaped and arranged together to prevent animals from moving or traveling under the fence 38 (i.e., under any gaps). In certain embodiments, an overhang section or portion 79 extends out past the edge 81 of the gate 18.

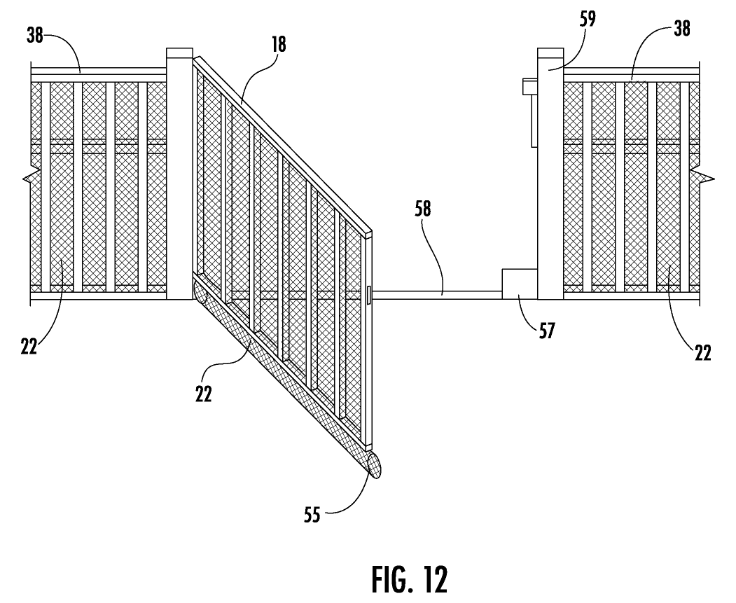

Referring to FIGS. 5A-17, aspects of installing various components of the animal barrier system 10 are provided. In describing embodiments relating to the methods of installation, additional structures which may form part of the animal barrier system 10 are described. Where gates 18 are used, a threshold 58 may be installed. For illustrative purposes, a 6-inch channel rubber speed bump 60 is used as a threshold. In certain embodiments, about 6-12 inches of grass or soil may be removed below the location of the gate 18. Materials, such as pea gravel (see 74, FIG. 8A), may be added to allow water to flow under, thus preventing soil movement. Soil or paver packing sand/paver joint sand may then be placed on top of the pea gravel 74, and compacted. The threshold 58, as illustrated the channel rubber speed bump 60 is then added and secured, i.e. staked in from vertical bar 75 to opposing vertical bar 76 of the fence 38, under the gate 18 (FIG. 11).

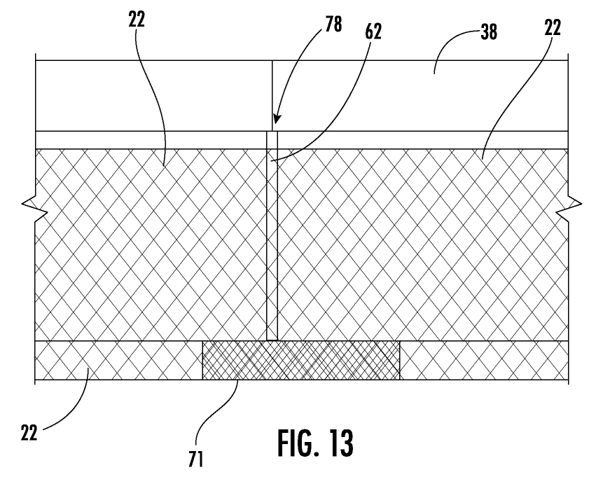

In certain embodiments, the mesh panel 22 (or any other barrier 20) may be rolled (made of excess mesh material rolled back on itself, acting similar to a hard edge or brush sweep; the rolled mesh 22 may form a shape, such as an L-shape) at the gate 18 to create a soft sweep, thus allowing movement of the gate 18, but still pressing to the threshold 58, see FIG. 12. This action creates a barrier that prevents some things from getting in (such as cane toads), but allows certain devices, such as lawn mowers, ease of movement in and out of the gate 18 without a permanent structure required. The mesh panel 22 is illustrated secured to the inside of the gate 18. While illustrated placed at the bottom of the gate 18, in certain embodiments, the rolled mesh panel 22 maybe placed along one or more other sections/portions of the fence 38. The rolled mesh panel 22 may include an overhang portion 55 extending past the bottom edge of the gate 18. In certain embodiments, a body 57 may be secured, view a screw, to a gate post 59 to provide an additional mechanism to prevent animals from entry at or through the gate 18 area. The body 57 designed to bend as the gate closes, and therefore may be a soft edging material.

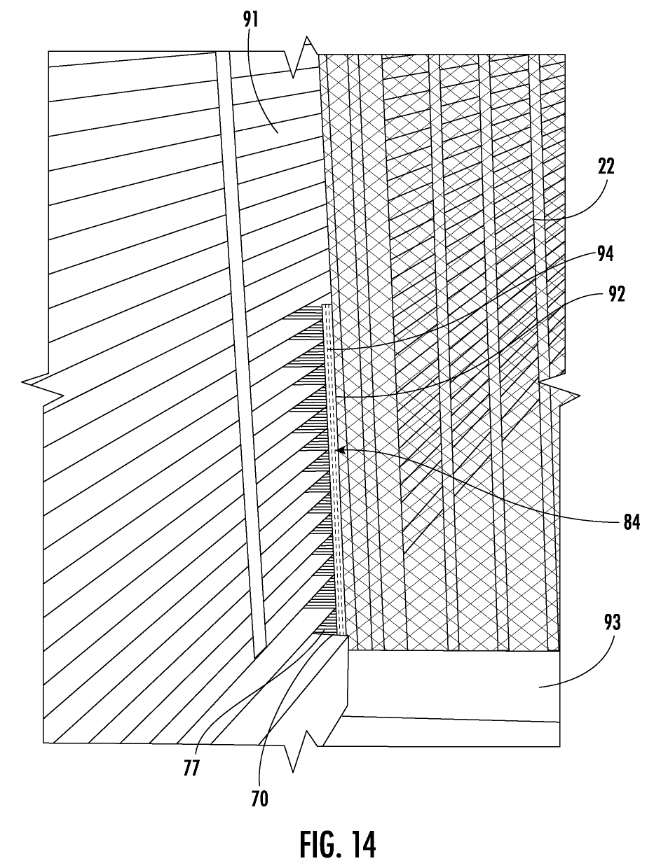

In certain embodiments, the mesh panels 22 are arranged to overlap, with any excess trimmed at a seam 78, see FIG. 13. This arrangement provides a clean view, but at the bottom, allows for the mesh to be overlapped (see 71) keeping cane toads, or any animal that digs, out or off the fence 38. This arrangement provides a seamless mesh fence having no openings, except at the gates 18, thereby reducing the likelihood of material breach by cane toads, or other creatures. In certain embodiments, the molding 62, such as an aluminum molding, may be used to seal the seam 78 between the mesh panels 22, or any other small gaps in the fencing 38. The molding 62 may be secured to the mesh panels 22 via securing members, such as screws or nails.

In certain embodiments, a hard-edging member 80 may be used, (see FIG. 5A and FIG. 5B) located along the edge of the fence and house wall 65 to seal any gaps. In an illustrative example, in addition to mesh panel 22 folding, a 4-inch or 5-inch edging may be used to seal any gaps 84 between the fence 38 and the structure the fence 38 attaches thereto, such as the house 86. The hard-edging member 80 may also be used with the threshold 58. In certain embodiments, the mesh 22 may extend, out around and past the hard-edging member 80, along portion of the structure it is attached to. As shown in FIG. 5B, the mesh 22 is attached to house wall 65 in such a manner as to prevent any possible gaps between the house wall 65 and portions of the animal barrier system 10, such as the hard-edging member 80.

In certain embodiments, one or more screws, or other fastening members, may be installed along a top rail 90 of the fence 38 (see FIG. 6) and along every other rail at the bottom, thus creating a tight barrier designed to reduce sagging.

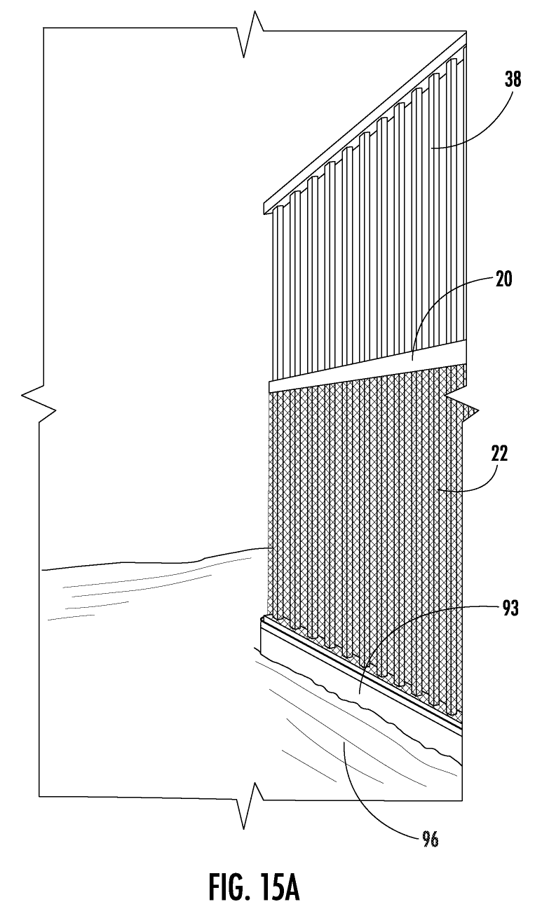

Referring to FIG. 10, in certain embodiments, the animal barrier system 10 includes and is installed at the bottom of the gate 18, the brush sweep 70. For gates 18, including electronic gates, the brush sweep 70 is configured to create a sweep at the bottom that keeps the cane toads and other critters out, without damaging the gates 18, or electronic motors of an electric gate. Referring to FIG. 14, the brush sweep 70 may also be used in various areas that are difficult to seal with the mesh panels 22 or edging 84. In this case, the brush sweep 70 is shown attached or secured via a metal frame 92 with groove 94 that is sized and shaped to hold the brush sweep 70. In the arrangement in FIG. 14, the barrier system 10 may be installed wherever there is wall (or a fence) made of vertical slates 93 (84 illustrating gapes between the slotted vents 91), thus providing an area where the animals (cane toads) could get past the meshed panel 22. The brush sweep 70 may be arranged or orientated to act as a deterrent, poking the cane toad or other animals in the face and eyes if they try to get through.

In certain embodiments, the mesh panels 22 are installed by digging into the ground 4-6 inches and burying a portion of the mesh panels 22 to avoid cane toads from digging under.

In certain embodiments, a 4-inch or 5-inch flat edging, 61, see FIG. 8B, may be used to seal all gaps in the gates 18. The flat edging 61 may be an elongated body 63, preferably a rigid or hard plastic body, running from the top of the animal barrier system 10 to the ground. The flat edging 65 may be secured to a building wall 65 and be designed to be flush with the or extend over parts of a bottom edging 93. The bottom edging 93 may be an elongated body made of a soft flexible material or a hard, rigid material.

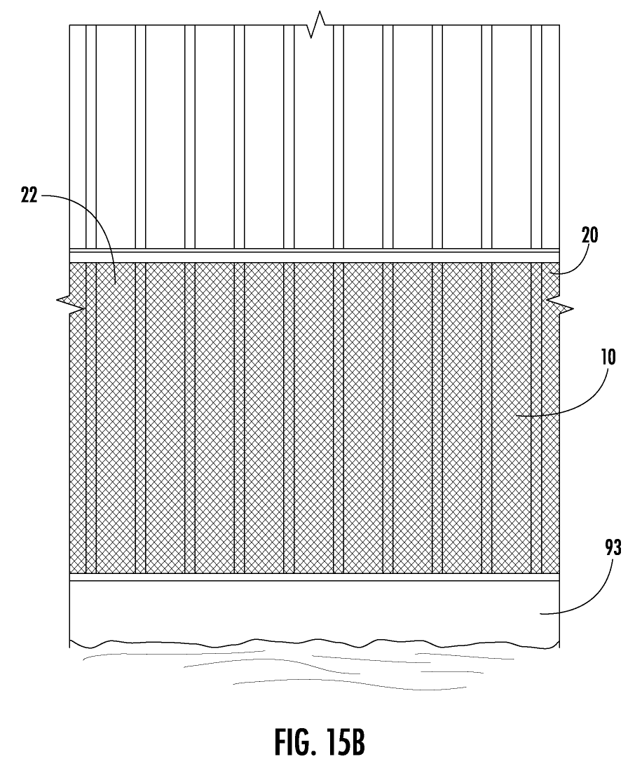

Referring to FIG. 15A, in certain embodiments, the bottom edging 93 (see also FIG. 15B) may be installed, for example, 4 inches to 5 inches to the bottom of the fence 38 on a grass area 96. This prevents wear and tear from various lawn care machines, such as grass trimmers.

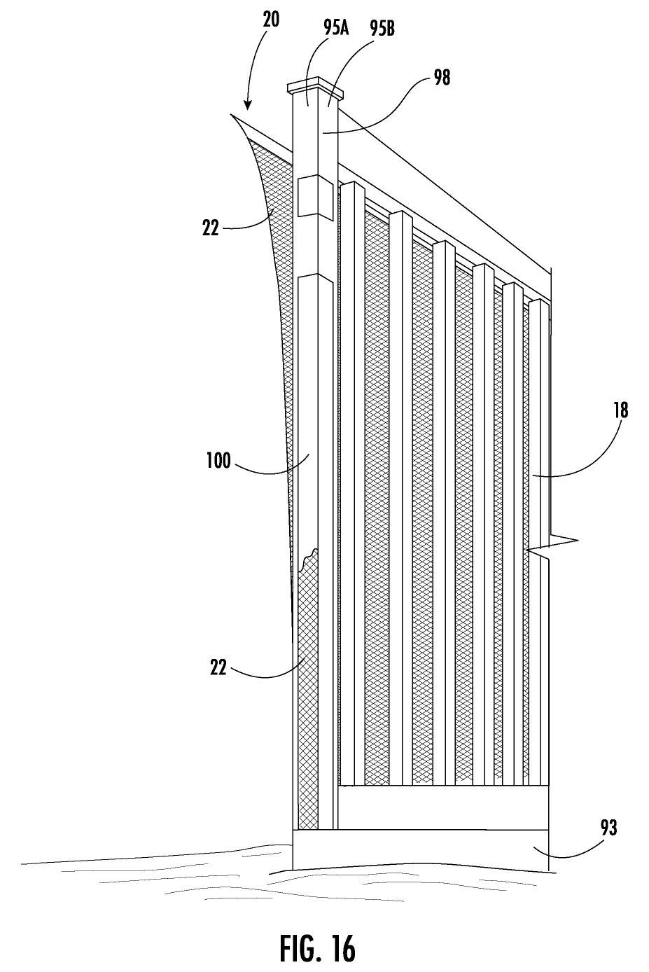

In certain embodiments, when sealing gates 18, hardware is removed on the gate 18 to place the mesh or screen panels 22 underneath, providing a flat finished look, while keeping the material as flat and flush to the gate 18 as possible, see FIG. 16. The mesh or screen panels 22 may then be rolled around any post(s) 98 to the inside of the gate 18 when possible (secured to surface 95A or 95B). Molding 100 is then added to seal the edges, positioned over/on top of the mesh 22 thereto, allowing the gate 18 to close flush (portions of the mesh 22 are shown extending past the post 98 and not under the molding 100 for illustrative purposes; when complete, the mesh 22 rests under the molding, except in some cases the upper portion of the mesh 22).

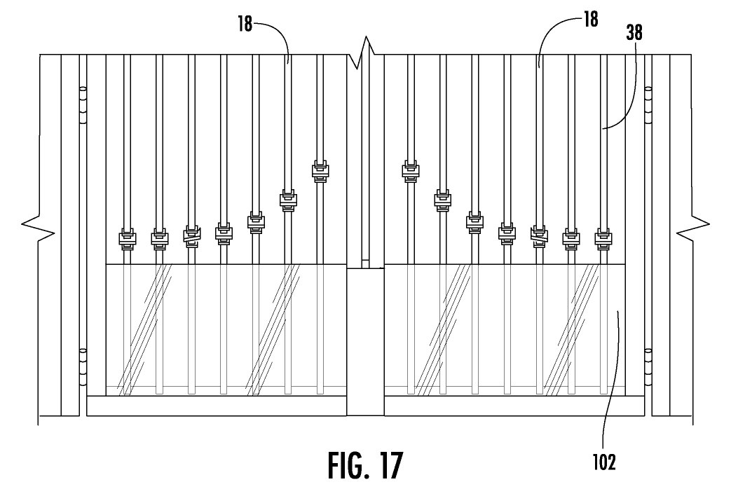

Referring to FIG. 17, a polycarbonate panel 102 is shown secured or attached to the gate 18, thus creating a clear view, no climb area on the fence 38.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of preventing or minimizing animal encounters within a predefined area, comprising:
providing an animal prevention barrier system constructed and arranged to prevent or minimize entrance of said animals within said predefined area;
to a preexisting fence enclosing said predefined area and having an upper edge and a lower edge, securing an animal prevention barrier system thereto;
if no preexisting fence encloses said predefined area, fencing said predefined area with a new fence structure having an upper edge and a lower edge to enclose said predefined area and securing said animal prevention barrier system thereto;
said animal prevention barrier system being secured to said preexisting fence or said new fence so that at least a portion of said prevention barrier system extends below a bottom edge of said preexisting fence or said new fence and into the ground supporting said preexisting fence or said new fence and a portion of said prevention barrier system extends towards said upper edge.

2. The method according to claim 1, wherein said at least a portion of said prevention barrier system extending below said bottom portion of said preexisting fence or said new fence extends at least 4-6 inches below said ground.

3. The method according to claim 1, wherein said at least a portion of said prevention barrier system extending above ground extends up to one half an overall height of said pre-existing fence height or said new fence height.

4. The method according to claim 1, wherein said animal prevention barrier system engages with said the said preexisting fence or said new fence via attachment to various sections or portions thereof.

5. The method according to claim 1, wherein said animal prevention barrier system comprises a screen or mesh panel.

6. The method according to claim 5, wherein said screen or mesh panel is defined by screen openings per square inch or centimeter of sufficient size to allow light, air, or combinations thereof of, to pass therethrough, but prevent said animal from using it to climb on or go through.

7. The method according to claim 1, wherein said animal prevention barrier system comprises a solid panel.

8. The method according to claim 7, wherein said solid panel is made of a plastic material.

9. The method according to claim 8, wherein said plastic material is a clear plastic material.

10. The method according to claim 1, further including placing or securing a threshold at or under said preexisting fence having a gate or said new fence having a gate.

11. The method according to claim 10, wherein said threshold is placed at or under a section of said preexisting fence or said new fence.

12. The method according to claim 10, wherein installation of said threshold includes the following steps:
removing about 6-12 inches of grass or soil from below said preexisting gate;
adding a material that allows flow of water to the area of removed grass or soil;
adding soil or paver packing sand to cover said material that allows flow of water; and
placing said threshold on top of said added soil or paver packing sand.

13. The method according to claim 1, further including securing a gap sealing member to said preexisting fence or said new fence.

14. The method according to claim 1, further including securing a brush sweep to said preexisting fence or said new fence.

15. The method according to claim 1, further including a bottom edging secured to said animal prevention barrier system, said bottom edging constructed and arranged to prevent damage from lawn care equipment.

16. The method according to claim 1, wherein said animal prevention barrier system is secured to an inner section of said preexisting fence or said new fence or to an outer section of said preexisting fence or said new fence.

17. The method according to claim 1, wherein said animal produces or releases toxins.

18. The method according to claim 1, wherein said animal is a jumping or hopping animal.

19. The method according to claim 1, wherein said animal that produces or releases toxins is Rhinella marina.
